(19) United States
(12) Patent Application Publication
(10) Pub. No.: US 2021/0147655 A1
(43) Pub. Date: May 20, 2021

(54) WIPER BLADE, PRODUCTION METHOD AND WIPER FRAME DEVICE CONTAINING NATURAL RUBBER AND POLYBUTADIENE

(71) Applicant: COMPAGNIE GENERALE DES ETABLISSEMENTS MICHELIN, Clermont-Ferrand (FR)

(72) Inventors: Bertrand JUILLARD, Clermont-Ferrand Cedex 9 (FR); Bozena VOGE, Clermont-Ferrand Cedex 9 (FR); Istvan MATYAS, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/628,166

(22) PCT Filed: Jul. 6, 2018
(86) PCT No.: PCT/FR2018/051707

§ 371 Date: Jan. 2, 2020

(30) Foreign Application Priority Data
Jul. 6, 2017 (FR) 1770722

(51) Int. Cl. C08L 7/00; C08L 9/00

(52) U.S. Cl. CPC C08L 7/00; C08L 9/00

(57) ABSTRACT

A wiper blade and notably a wiper blade comprising a rubber structure, a method for producing the blade, as well as a wiper frame device, is provided. The rubber structure is formed from an elastomer matrix comprising: from 25 to 60 phr of natural rubber; and from 40 phr to 75 phr of polybutadiene.

This application is a 371 national phase entry of PCT/FR2018/051707 filed on 6 Jul. 2018, which claims benefit of French Patent Application No. 1770722, filed 6 Jul. 2017, the entire contents of which are incorporated herein by reference for all purposes.

### BACKGROUND

### 1. Field of the Invention

The present invention relates to a wiper blade and notably a wiper blade comprising a rubber structure. The invention further relates to a method for producing the blade, as well as a wiper frame device.

### 2. Related Art

Motor vehicles are commonly equipped with windscreen wiper systems. These systems provide washing of the windscreen and prevent disturbance of the driver's view of his environment. Windscreen wipers are conventionally driven by wiper arms performing angular to-and-fro movements and keeping the wipers extended, which in turn carry wiper blades that are made, at least partially, of an elastic material. These blades are called wiper blades. They rub against the windscreen and remove water, leading it out of the driver's field of view.

Conventionally, wipers are made in the form of hinged bars that hold the wiper blade in several discrete places. In a more recent version called “flat blade”, the wipers form a semirigid assembly that holds the wiper blade over its entire length.

The wiper blades according to the prior art are made of natural rubber (NR) or of synthetic elastomers, such as nitrile rubber (NBR), styrene-butadiene rubber (SBR), ethylene-propylene-diene rubber (EPDM), ethylene-propylene rubber (EPM), and mixtures of these elastomers. They generally have a triangular shape that gets narrower towards the bottom, the lower vertex of which moves over the windscreen, and the upper side of which is attached by a thin elastic band to the body of the wiper. On deforming, this thin band allows the wiper blade to slope towards the windscreen, in one direction and then in the other, during the to-and-fro movements of the wiper.

The wiper blades, and in particular the lower vertex of the triangular shape of these blades in contact with the windscreen, are subjected to repeated rubbing. This rubbing causes abrasion of the blades, which leads to ageing of the latter. Thus, after a certain number of cycles, the blades must be changed.

Furthermore, wiper blades, whether made of natural rubber or synthetic rubber, are liable to deteriorate more or less quickly after prolonged exposure to the atmosphere on account of known mechanisms of oxidation and ozonolysis.

There is therefore a need to improve and/or supplement the known compositions in order to obtain wiper blades having improved properties of abrasion resistance, good residual compression set, good fatigue strength and good resistance to ozone and to oxidation.

### SUMMARY

Taking the foregoing into account, one problem to be solved by the invention is to develop a new wiper blade comprising a rubber structure, which has good resistance to abrasion, to fatigue and, advantageously, to ultraviolet radiation and ageing by ozone.

According to the invention, the solution to this problem relates firstly to a wiper blade comprising a rubber structure, characterized in that the structure is formed from an elastomer matrix comprising:
from 25 to 60 phr, parts by weight per hundred parts by weight of elastomer, of natural rubber; and
from 40 to 75 phr of polybutadiene.

The invention relates secondly to a method for producing a wiper blade comprising the following steps:
mixing the composition;
molding the composition in a wiper blade mold; and
crosslinking the composition in the wiper blade mold.

The invention relates thirdly to a wiper frame device for motor vehicles, comprising a wiper blade as defined in the present invention.

Advantageously,
the rubber structure further comprises at least 4 phr of protective agents, the protective agents comprising at least one antioxidant and at least one antiozonizing agent;
the rubber structure comprises from 1 to 6 phr of at least one antioxidant; the antioxidant is selected from N-(1,3-dimethylbutyl)-N′-phenyl-1,4-phenylenediamine, the polymer 2,2,4-trimethyl-1,2-dihydroquinoline, 2,2′-methylenebis(6-tert-butyl-4-methylphenol), N,N′-diphenyl-p-phenylenediamine, 2,6-ditert-butyl-4-methylphenol, N-isopropyl-N′-phenyl-1,4-phenylenediamine, 3,9-di-3-cyclohexen-1-yl-2,4,6,10-tetraoxaspiro[5.5]undecane, bis(1-octyloxy-2,2,6,6-tetramethyl-4-piperidyl)sebacate, octyl 3-[3-(2H-benzotriazol-2-yl)-5-tert-butyl-4-hydroxyphenyl]propionate, methyl-2-mercaptobenzimidazole and mixture thereof;
the wiper blade comprises from 1 to 3 phr of at least one antiozonizing agent; the antiozonizing agent is selected from ozone waxes, the polymer 2,2,4-trimethyl-1,2-dihydroquinoline, paraphenylenediamines and mixture thereof;
the rubber structure further comprises at least 40 phr of a particulate reinforcing filler;
at least 3 phr of an oil;
at least 0.5 phr of at least one vulcanization activator; and
at least 0.6 phr of at least one vulcanization accelerator or ultra-accelerator;
the particulate reinforcing filler is selected from carbon black or silica;
If the particulate reinforcing filler is silica, an elastomer-silica bonding agent will be added. This bonding agent will be Tri Ethoxy-Silyl-Propyl-Tetrasulfide. At least 2.4 phr of this silane will then be added. Other types of silane such as Si75 or NXT may be used.
the vulcanization activator is selected from stearic acid, zinc oxide, and mixtures thereof;
the vulcanization accelerator and/or ultra-accelerator are selected from sulfur, sulfenamide, benzothiazyl sulfenamide, TBzTD and mixtures thereof.

### BRIEF DESCRIPTION OF THE DRAWINGS

The invention will be better understood on reading the nonlimiting description given hereunder, written with respect to the figures:

FIG. 1, which shows a wiper blade comprising a structure made of rubber; and

FIG. 2 shows dimensions of test specimens according to an example embodiment.

### DETAILED DESCRIPTION OF THE EXAMPLE EMBODIMENTS

In the present description, unless expressly stated otherwise, all the percentages (%) indicated are percentages (%) by weight. Moreover, any range of values denoted by the expression “between a and b” represents the range of values from more than a to less than b (i.e. limits a and b excluded) whereas any range of values denoted by the expression “from a to b” signifies the range of values from a to b (i.e. including the strict limits a and b).

The expression “part by weight per hundred parts by weight of elastomer” (or phr) means, in the sense of the present invention, part by weight per hundred parts by weight of elastomer.

The compounds comprising carbon mentioned in the description may be of fossil origin or biosourced. In the latter case, they may be derived partially or completely from biomass or obtained from renewable raw materials derived from biomass. This relates notably to the polymers, the plasticizers, the fillers, etc.

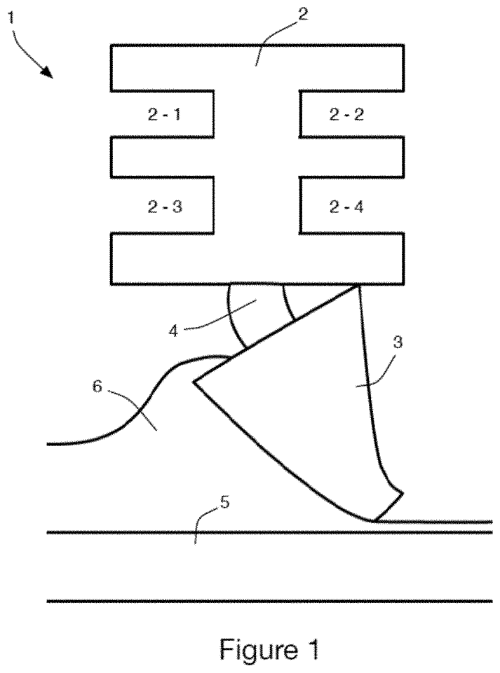

The invention relates to a wiper blade. As is shown in FIG. 1, the blade 1 has a base 2 and a blade 3 hinged on the base 2 by a hinge 4.

The base 2 is attached to the body of the wiper not shown in FIG. 1. It has two pairs of longitudinal cavities 2-1, 2-2, 2-3, 2-4. These longitudinal cavities are arranged on either side of the base 2. The first 2-1, 2-2 of the two pairs of cavities, arranged at an upper level, serves for receiving a stiffening element consisting either of two metal blades arranged longitudinally on either side of the base 2, or of a strip that covers the upper part of the base 2, having its free edges interacting with the aforementioned pair of cavities 2-1, 2-2. The second 2-3, 2-4 of the pairs of cavities, arranged at a level below that of the aforementioned pair of cavities, serves for receiving the holding claws that the wiper frame usually has for carrying the windscreen wiper blade 1. The blade 3 generally has a triangular shape that gets narrower towards the bottom, the lower vertex of which moves over the windscreen of a motor vehicle and the upper side of which is attached to the base 2 by the hinge 4 formed of a thin elastic band. On deforming, the hinge 4 allows the windscreen wiper blade 1 to incline towards the windscreen, in one direction and then in the other, during the to-and-fro movements of the wiper. The blade 3 removes water 6 from the windscreen 5 in the direction of these to-and-fro movements.

The windscreen wiper blade 1 comprises a rubber structure. This rubber structure constitutes the blade 3, or the terminal end of this blade 3 in contact with the windscreen 5. Advantageously, it further constitutes the hinge 4 and, optionally, the base 2 or, in one embodiment according to the invention, the whole of the blade 1.

The rubber structure of the wiper blade according to the invention comprises an elastomer matrix. This elastomer matrix is unsaturated. It does not comprise halogen.

This elastomer matrix comprises from 25 to 60 phr, and preferably from 30 to 55 phr, of natural rubber (NR). For example, the matrix comprises approximately 35 phr of natural rubber. In another example, the matrix comprises approximately 50 phr of natural rubber. Natural rubber is an elastomer widely used in the tire sector on account of its remarkable properties, for example such as good resilience, good tensile strength, tear strength and fatigue strength. It is also used as wiper blade material. In this context, vulcanized natural rubber displays good wiping performance as well as good endurance.

The elastomer matrix according to the invention also comprises from 40 to 75 phr, and preferably from 40 to 70 phr, of polybutadiene (BR). For example, the matrix comprises approximately 65 phr of polybutadiene. In another example, the matrix comprises approximately 50 phr of polybutadiene. Polybutadiene results from the polymerization of buta-1,3-diene, called butadiene, of semi-structural formula H₂C═CH—CH═CH₂. Chain polymerization of butadiene may be carried out by various methods. It leads to three different polyunsaturated microstructures: the units 1,4-cis, 1,4-trans and 1,2. Polybutadiene is known to have very good abrasion resistance. These qualities are maintained at low temperature. Moreover, polybutadiene slides on a wetted substrate. Each repeating unit of polybutadiene bears a reactive residual double bond. Vulcanization makes it insoluble. In the context of the present invention, the use of polybutadiene endows the elastomer matrix with greatly improved properties of abrasion resistance, better durability of the wiper blade over time, notably when the wiper blade is subjected to large temperature variations, and better endurance.

The matrix according to the invention is therefore an NR-BR matrix, i.e. 100 phr of the matrix is formed either of natural rubber NR, or of polybutadiene.

According to the invention, the rubber structure of the wiper blade further comprises one or a plurality of protective agents. “Protective agents” means compounds that confer resistance to degradation due to UV radiation and/or ozone. In one embodiment according to the invention, the rubber structure comprises a mixture of protective agents comprising at least one antioxidant and at least one antiozonizing agent.

Advantageously, the antioxidant is selected from N-(1,3-dimethylbutyl)-N′-phenyl-1,4-phenylenediamine (6PPD), the polymer 2,2,4-trimethyl-1,2-dihydroquinoline (TMQ), 2,2′-methylenebis(6-tert-butyl-4-methylphenol), N,N′-diphenyl-p-phenylenediamine, 2,6-di-tert-butyl-4-methylphenol, N-isopropyl-N′-phenyl-1,4-phenylenediamine, 3,9-di-3-cyclohexen-1-yl-2,4,6,10-tetraoxaspiro[5.5]undecane, bis(1-octyloxy-2,2,6,6-tetramethyl-4-piperidyl)sebacate, octyl 3-[3-(2H-benzotriazol-2-yl)-5-tert-butyl-4-hydroxyphenyl]propionate, methyl-2-mercaptobenzimidazole and mixtures thereof.

Advantageously, the antiozonizing agent is selected from antiozone waxes, the polymer 2,2,4-trimethyl-1,2-dihydroquinoline and paraphenylenediamines. More particularly, the antiozone wax is of the type “C32ST” or “C36ST”.

According to the invention, the rubber structure comprises at least 4 phr, and preferably at least 5 phr, of protective agents. The level of protective agents is therefore greatly increased relative to the level of the agents contained in compositions used notably in windscreen wipers. More particularly, the rubber structure comprises from 1 to 6 phr of at least one antioxidant, and from 1 to 3 phr of at least one antiozonizing agent.

Moreover, according to the invention, the rubber structure further comprises at least 40 phr, and preferably at least 50 phr, of a particulate reinforcing filler. For example, the rubber structure comprises approximately 55 phr of a particulate reinforcing filler. In one example, this particulate reinforcing filler is carbon black.

The rubber structure according to the invention further comprises at least 3 phr, and preferably from 4 to 20 phr, of an oil. In one example, this structure comprises approximately 5 phr of an oil. In another example, the structure comprises about 19 phr of an oil. The presence of oil degrades the resistance of the structure to oxidation and/or to ozone, but makes it possible to regulate the viscosity in the manufacture of this structure.

The rubber structure further comprises at least 0.5 phr, and preferably at least 1 phr, of at least one vulcanization activator. Advantageously, the vulcanization activator is selected from stearic acid, zinc oxide, and mixtures thereof.

Finally, the rubber structure according to the invention advantageously comprises at least 1 phr of sulfur and at least 0.6 phr of at least one vulcanization accelerator and/or ultra-accelerator, the vulcanization accelerator or ultra-accelerators being selected from sulfenamide, benzothiazyl sulfenamide, TBzTD, TMTD and mixtures thereof.

The invention also relates to a method for producing a wiper blade comprising the following steps:
mixing the elastomer composition as described above without the vulcanizing agents and accelerators and/or ultra-accelerators;
filtering the masterbatch in a filtration machine with a filter of mesh 80;
adding the vulcanizing agents as well as the accelerators;
molding the composition in a wiper blade mold; and
crosslinking the composition in the wiper blade mold.

More particularly, production of the elastomer composition is carried out according to the mixing method called “Upside-Down” (USD). This method consists firstly of incorporating the rubber, the fillers and the protective agents. The various components are mixed by stirring for a time of between 3 and 7 minutes. The mixture is discharged at a temperature between 150 and 170° C.

The composition comprising rubber, the fillers and the protective agents is then cooled on a roll tool at a temperature between 30 and 60° C. This composition is then filtered in a filtration machine with a filter size of mesh 80. The vulcanization system is then incorporated therein at a temperature between 70° C. and 110° C. The mechanical work of mixing is carried out for a time between 3 and 7 min. Finally, cooking for molding the wiper blades is carried out at a temperature between 160 and 170° C.

The invention finally relates to a wiper frame device for motor vehicles, characterized in that it comprises a wiper blade as defined above.

### EMBODIMENT EXAMPLE OF THE INVENTION

The example given below illustrates the invention, but the latter is not limited to this single example.

The aim of this test is to demonstrate the improvement in performance in terms of rubber-making properties of several compositions according to the invention relative to a conventional control composition for wiper blades.

All of the compositions were prepared according to the method described in detail above. These compositions are defined as follows:
the control composition T1 is a “conventional” wiper blade composition notably including natural rubber, carbon black and protective agents,
composition C1 according to the present invention includes a mixture of natural rubber and polybutadiene, a level of carbon black lower than T1 and a level of protective agents greater than that of composition T1,
composition C2 according to the present invention is identical to composition C1 except for the elastomer mixture of the composition,
composition C3 according to the present invention includes a mixture of natural rubber and polybutadiene different from that of composition C1, a level of carbon black and of protective agents identical to those of composition C1, and a level of plasticizer and crosslinking system adapted to the difference in fluidity of the polybutadiene used.

The levels of the various constituents of the compositions expressed in phr, part by weight per hundred parts by weight of elastomer, are presented in Table 1 below:

TABLE 1

| Compositions | T1 | C1 | C2 | C3 |
|---|---|---|---|---|
| NR | 100 | 50 | 35 | 50 |
| BR (1) | | 50 | 65 | 50 |
| BR (2) | | | | |
| CARBON BLACK (3) | 75 | 50 | 50 | 50 |
| PLASTICIZING OIL | 5 | 5 | 5 | 19 |
| 6PPD | 1.5 | 3.3 | 3.3 | 3.3 |
| TMQ | 1.5 | 1.5 | 1.5 | 1.5 |
| WAX | 1 | 1.5 | 1.5 | 1.5 |
| STEARIC ACID | 1 | 1 | 1 | 1 |
| ZnO | 3 | 3 | 3 | 2.4 |
| SOLUBLE SULFUR BLOCK | 1.9 | 1.9 | 1.9 | 0.55 |
| TBBS 70% | 0.95 | 0.95 | 0.95 | 0.95 |

(1) Polybutadiene Neodymium 98% of 1,4-Cis, Tg = −108° C., elastomer Mooney = 44,
(2) Polybutadiene Neodymium 98.4% of cis, 1% of trans, 0.6% of BD1.2, Tg −109° C., Elastomer Mooney = 63,
(3) Carbon black N347 marketed by the company Cabot Corporation.

Conventionally, the tearing and fatigue tests were carried out on these mixtures. The tearing tests were carried out at 23° C. using so-called “DZ” test specimens (cf. FIG. 2).

These test specimens were placed in the jaws of a machine of the INSTRON type and were stretched at 500 mm/min until rupture to determine the transverse displacement at break and the tearing strength.

In addition, fatigue strength tests were carried out on the rubber structure of the present example. The purpose of these tests is to measure the life of a test specimen subjected to repeated tension on a machine of the M.F.T.R. type (Machine de Fatigue par Tractions Répétées—Repeated Tension Fatigue Tester).

Furthermore, tests of abrasion resistance were carried out. In these tests, the erosion of the rubber structure of the present example was measured by sliding a rubber shoe on a cylinder covered with abrasive paper. The value obtained for abrasion resistance corresponds to the loss of volume.

In addition, tests of resistance to ozone and UV ageing were carried out. The condition of the surface of the test specimens is observed with the naked eye after ageing at a temperature 38° C. and an ozone concentration of 50 pphm.

Finally, tests of compression set were carried out according to standard ASTM D935B.

All of the measurements carried out for compositions T1, C1, C2 and C3 are reported in Table 2 below.

TABLE 2

| Compositions | T1 | C1 | C2 | C3 |
|---|---|---|---|---|
| Abrasion (loss of | 191 | 45 | 34 | 47 |
| volume in mm³) | | | | |
| Tearing strength | 147 | 370 | 537 | 388 |
| deformation % | | | | |
| Tearing strength force | 77 | 67 | 69 | 65 |
| (N/mm) | | | | |
| Fatigue (number of | 26 | 270 | 458 | 261 |
| Kcycles before break) | | | | |
| Ozone Resistance | Break at | No | No | No |
| | 6 days | cracking | cracking | cracking |
| UV Resistance | Visible | No | No | No |
| | cracking | cracking | cracking | cracking |
| Compression set % | 23.8 | 13.8 | 22.7 | 12.3 |

The test results in Table 2 show, surprisingly, that all the compositions according to the invention (C1, C2, C3) with different mixture proportions or with different polybutadienes, have abrasion resistance of this structure that is quite definitely improved relative to the control composition T1 (much lower losses of volume), and that this is also the case for the properties of fatigue strength (number of Kcycles very much greater).

Compositions C1 to C3 according to the invention also all have much improved tearing stretch in deformation relative to the control composition T1 without degradation of the tearing strength in Force.

Similarly, it can be seen that the compositions according to the invention have very significantly improved properties of resistance to ozone and UV ageing relative to the control composition.

Finally, all the formulations according to the invention have, surprisingly, excellent properties of abrasion resistance and fatigue strength as well as very good properties of tearing strength and resistance to ozone and UV ageing, which are, moreover, clearly improved relative to those known from the prior art, while maintaining a residual compression set identical to the control composition or even improved for compositions C1 and C2.

1. A wiper blade comprising a rubber structure, said structure is formed from an elastomer matrix comprising:
from 25 to 60 parts by weight per hundred parts by weight of elastomer, phr, of natural rubber; and
from 40 to 75 phr of polybutadiene.

2. The wiper blade according to claim 1, wherein the elastomer matrix comprises:
from 30 to 55 phr of natural rubber; and
from 40 to 70 phr of polybutadiene.

3. The wiper blade according to claim 1, wherein the rubber structure further comprises at least 4 phr of a mixture of protective agents, said mixture of protective agents comprising at least one antioxidant and at least one antiozonizing agent.

4. The wiper blade according to claim 3, wherein the rubber structure comprises from 1 to 6 phr of at least one antioxidant.

5. The wiper blade according to claim 3, wherein the antioxidant is selected from N-(1,3-dimethylbutyl)-N′-phenyl-1,4-phenylenediamine, the polymer 2,2,4-trimethyl-1,2-dihydroquinoline, 2,2′-methylenebis(6-tert-butyl-4-methylphenol), N,N′-diphenyl-p-phenylenediamine, 2,6-ditert-butyl-4-methylphenol, N-isopropyl-N′-phenyl-1,4-phenylenediamine, 3,9-di-3-cyclohexen-1-yl-2,4,6,10-tetraoxaspiro[5.5]undecane, bis(1-octyloxy-2,2,6,6-tetramethyl-4-piperidyl)sebacate, octyl 3-[3-(2H-benzotriazol-2-yl)-5-tert-butyl-4-hydroxyphenyl]propionate, methyl-2-mercaptobenzimidazole and mixtures thereof.

6. The wiper blade according to claim 3, wherein the wiper blade comprises from 1 to 3 phr of at least one antiozonizing agent.

7. The wiper blade according to claim 4, wherein the antiozonizing agent is selected from ozone wax, the polymer 2,2,4-trimethyl-1,2-dihydroquinoline, paraphenylenediamines and mixtures thereof.

8. The wiper blade according to claim 1, wherein the rubber structure further comprises at least 40 phr of a particulate reinforcing filler;
at least 3 phr of an oil;
at least 0.5 phr of at least one vulcanization activator; and
at least 0.6 phr of at least one vulcanization accelerator.

9. The wiper blade according to claim 8, wherein the particulate reinforcing filler is carbon black;
the vulcanization activator is selected from stearic acid, zinc oxide, and mixtures thereof;
the vulcanization accelerator is selected from sulfur, sulfenamide, benzothiazyl sulfenamide, and mixtures thereof.

10. A method for producing a wiper blade comprising the following steps:
mixing the elastomer composition according to claim 1; then
filtering the masterbatch in a filtration machine with a filter of mesh 80;
adding the vulcanizing agents as well as the accelerators;
molding said composition in a wiper blade mold; and then
crosslinking the composition in the wiper blade mold.

11. A wiper frame device for motor vehicles, wherein the device comprises a wiper blade according to claim 1.
